(19) United States
(12) Patent Application Publication
(10) Pub. No.: US 2010/0129484 A1
(43) Pub. Date: May 27, 2010

(54) MOLD SYSTEM FOR PRODUCING OPHTHALMIC DEVICES

(76) Inventors: Scott Ansell, Jacksonville, FL (US); Vincent Barre, Jacksonville, FL (US); Richard Fox, Jacksonville, FL (US); Marc Ansems, Casteren (NL); Marnik Vaes, Zonhoven (BE)

Correspondence Address: HISCOCK & BARCLAY, LLP, 2000 HSBC PLAZA, 100 Chestnut Street, ROCHESTER, NY, 14604-2404, US

(21) Appl. No.: 12/616,275

(22) Filed: Nov. 11, 2009

Related U.S. Application Data
(60) Provisional application No. 61/200,239, filed on Nov. 26, 2008.

(51) Int. Cl. B29C 45/10

(52) U.S. Cl. 425/191; 425/190; 425/192 R

(57) ABSTRACT

A molding system for forming ophthalmic devices includes at least one mold half having a base wherein the at least one mold half is configured to be engaged by an injection molding machine, at least one insert retainer, the at least one insert retainer being configured to receive a plurality of inserts wherein each of the inserts is configured to receive thermoplastic material for forming at least one lens curve wherein the at least one mold half is configured to receive the at least one insert retainer, and means for attaching the at least one insert retainer to the at least one mold half.

### PRIORITY CLAIM

Priority is claimed from U.S. provisional patent application Ser. No. 61/200,239, entitled “Mold System for Producing Ophthalmic Devices” filed Nov. 26, 2008, which is fully incorporated herein by reference.

### TECHNICAL FIELD

The present invention relates to molds and molding machines for producing ophthalmic devices and more particularly, to an improved system for manufacturing and storing contact lenses.

### BACKGROUND INFORMATION

Prior art injection molding machines for the manufacture of contact lenses typically comprise two mold halves such as those taught by Homer et al. in U.S. Pat. No. 5,252,056. Homer et al. provides a contact lens manufacturing process wherein two mold halves, manufactured by injection molding, are configured to be joined together. One mold half has a convex shape and the other has a concave shape. A material such as a liquid monomer mixture is introduced between the mold halves such that when the mold halves are joined together, and the material undergoes a polymerization process, a contact lens is formed having a least one optically critical side and a mostly perfect edge which can be subsequently manipulated as necessary. The molds themselves are then used to transport and store the contact lenses. This serial manufacture of contact lenses requires significant cycle time due to the successive swapping of mold halves.

In U.S. Pat. No. 5,782,460, incorporated herein by reference, a molding system is provided that forms ophthalmic devices having a geometry determined by the contour of the two mold halves in the region in which they are in contact with one another such as female and male inserts. The female inserts receive a flowable starting material in excess of that required to form a contact lens and the mold halves are closed. When the mold halves are closed a polymerization process occurs allowing the contact lens material to be fully cured. In prior art molding systems such as that taught in the '460 patent, the molds were disposable and only used once due, at least in part, to their contamination from the excess material or deformation, for example.

U.S. Pat. Nos. 6,592,356 and 7,156,638 to Lust et al., both incorporated herein by reference, describe an apparatus for molding ophthalmic devices such as contact lenses, interocular lenses, and lens curves used for making contact lenses. An injection molding machine is provided with a hot runner in the base of the apparatus configured to provide molten thermoplastic material, e.g. polystyrene, to a first mold half and a second mold half wherein each half is configured to produce front lens curve(s) and/or back lens curve(s). Further, a second mold half includes a plate mounted on the hot runner base which has been bored out to receive inserts configured to form the non-critical surfaces of the lens curves a first mold half includes changeable cassette(s), or insert retainers, which are removably attached to the base of the first mold half and which comprise a plurality of inserts.

Removable cassettes allow for reduced cycle time because removing and replacing a mold half may require the use of a hoist due to its relative size and weight as compared to a cassette. Therefore, cassettes are more easily moved and stored and allow for a significant increase in efficiency, particularly in the case of serial manufacture of stock keeping units (SKUs). SKU refers to ophthalmic devices having different powers, cylinders, and/or axis values for example, such that a different mold, mold orientation, and/or reactive mixture within the mold is required. Further, since an optimum molding temperature range is required to produce effective lens curves, cassettes allow for reduced preheating because upon removal and replacement of successive cassettes in a mold base, the mold base will have retainer at least some heat resulting in less down-time and less waste.

There is a need in the art for an improved system and method for manufacturing and storing contact lenses which increases the efficiency of insert changes and device storage in order to reduce cycle time, downtime, and required storage space.

### BRIEF DESCRIPTION OF THE DRAWINGS

These and other features and advantages will be better understood by reading the following detailed description, taken together with the drawings wherein:

FIG. 1 is a perspective view of a first mold half.

FIG. 2 is a perspective view of a second mold half.

FIG. 3a is a perspective view of an insert retainer including a plurality of inserts.

FIG. 3b is a side plan view of an insert retainer.

FIG. 4 is a front view of an insert retainer including an insert cooling medium.

FIG. 5a is a top perspective view of an insert retainer having at least one vented channel.

FIG. 5b is a perspective close-up view of an insert retainer having a vented channel.

FIG. 6a is a perspective view of an insert retainer including inserts engaged by a 45 degree rotational indexer.

FIG. 6b is a plan view of a 90 degree rotational indexer.

FIG. 6c is a perspective view of an insert retainer including inserts engaged by a 90 degree rotational indexer.

FIG. 6d is a plan view of a 90 degree rotational indexer.

FIG. 7 is a perspective view of an insert retainer and a mold base including a preloaded protrusion.

FIG. 8 is a perspective view of an insert retainer including at least one preloaded key.

FIG. 9a is a perspective view of an insert retainer including a threaded aperture.

FIG. 9b is a side view of a mounting screw.

FIG. 10 is a side schematic of a cylinder lock and male knob.

FIG. 11a is a side schematic of handle including a button actuation system.

FIG. 11b is a perspective view of an opaque retainer holder and cover including a handle.

FIG. 11c is a side perspective transparent view of a cover and a retainer holder including a threaded protrusion and a threaded cap.

### DETAILED DESCRIPTION

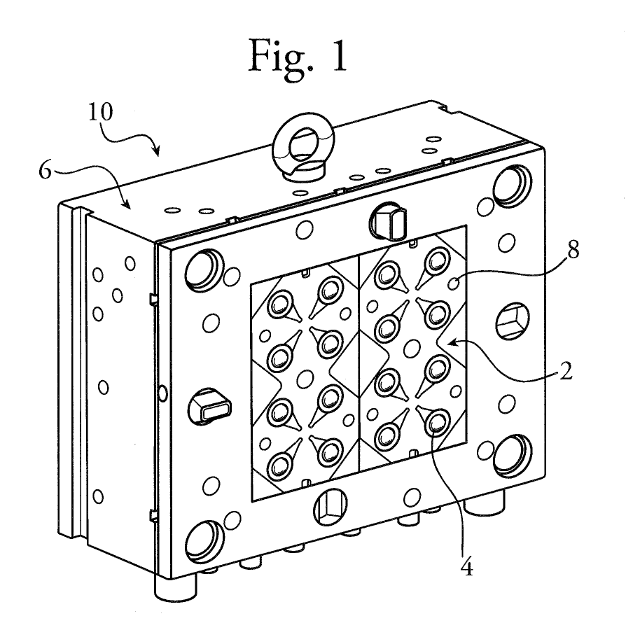

Referring to FIG. 1, a first mold half 10 can have a base 6 including at least one insert retainer 2 having at least one insert 4. The first mold half 10 can be a moveable mold half having at least one cooling channel. FIG. 1 shows a first mold half having two insert retainers 2 of a rectangular shape each having eight insert apertures and eight associated convex inserts 4. However, the present invention is not limited to any number of insert retainers, any shape of the insert retainers, or any number of inserts. The insert retainers 2 shown in FIG. 1 are attached by mounting screws 8 but brackets, braces, quick clamps, bolts, rods, and magnets are also contemplated as means for attaching an insert retainer 2 to a mold half 6. A coupling system utilizing mechanical, pneumatic, spring, or hydraulic forces is also contemplated as a means for attaching an insert retainer 2 to a mold half 6, as discussed further below.

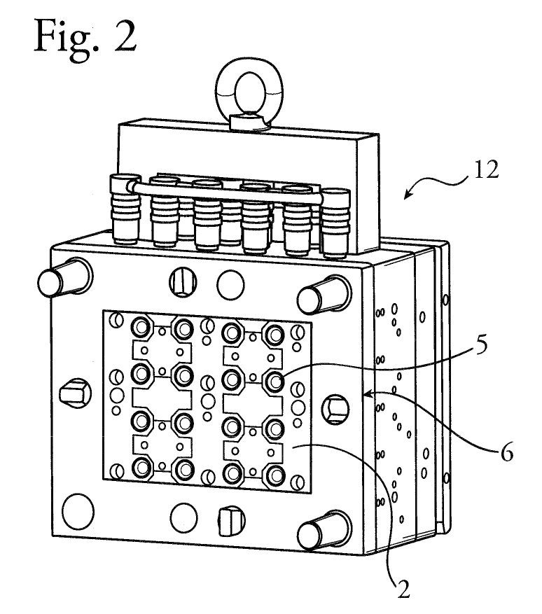

Referring to FIG. 2, a second mold half 12 having a base 6 can include at least one insert retainer 2 having at least one insert 5. The second mold half 12 can be a fixed mold half 12 having at least one cooling channel. FIG. 2 shows a second mold half having two insert retainers 2 of a contoured shape each having eight insert apertures and eight associated concave inserts 5. The second mold half 12 can include a base 6 which can include a hot runner configured to deliver material, such as molten thermoplastic material for example, for forming ophthalmic devices, such as lens curves for example, to the inserts 5.

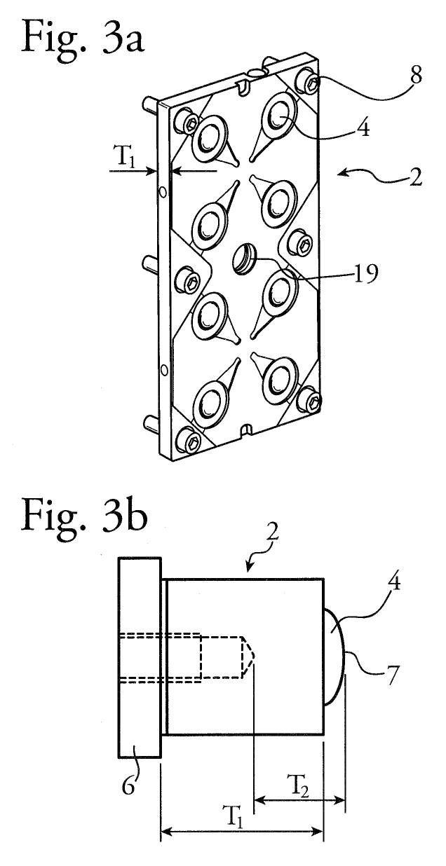

Referring to FIG. 3a, one embodiment of an insert retainer 2 is shown having eight convex inserts 4, each attached to a respective insert aperture. An insert retainer 2 can also have a retainer hole 19 as shown in FIG. 3a and as discussed in more detail below. An insert retainer 2 can also have a thickness T1 and at least one mounting screw 8 as discussed further below. In order to achieve increased efficiency of heat transfer from a base, which can have a cooling medium (not shown), to an insert 4, the insert retainer 2 thickness T1 can be minimized. Referring to FIG. 3b, in order to reduce thickness T1, thickness T2, which represents the distance measured from the manufacturing hole to the optical surface 7, can be reduced such that structural integrity of the insert 4 is maintained during the injection molding process. Reducing the two thicknesses T1 and T2 can have the effect of increasing the heat transfer from the cooling medium to the insert 4 due to the increased proximity of the two components. Accordingly, since an optimum molding temperature range is required to produce effective lens curves, increased heat transfer to the inserts 4 can result in reduced down-time and increased cycle time. Preferably, insert retainer 2 thickness T1 can be not greater than 15 millimeters, and more preferably, in the case of an insert retainer 2 having convex inserts 4, the insert retainer 2 thickness T1 can be not greater than 10 millimeters.

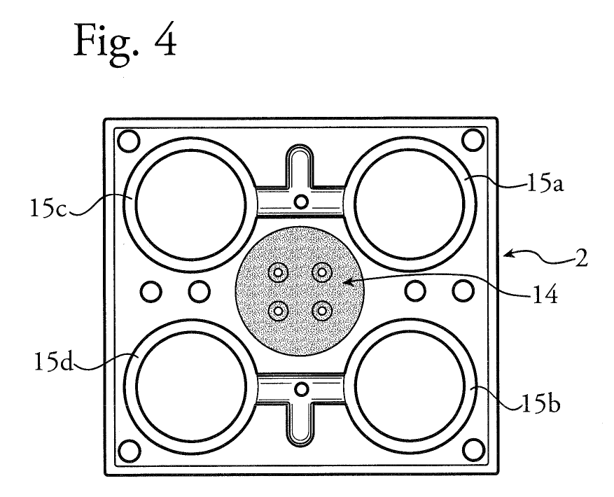

Referring to FIG. 4, an insert retainer 2 is shown including a retainer cooling medium 14 disposed in a substantially central location as compared to the four insert apertures 15, each insert aperture 15 being configured to receive an insert. The retainer cooling medium 14 can include a conductive alloy such as copper, copper chromium, copper zinc, brass, and nickel-coated brass, for example. Preferably, the mold base 6 includes a base cooling medium (not shown) comprised of the same material as the retainer cooling medium 14 and located such that when an insert retainer 2 is received by a mold half 10, 12 the base cooling medium and the retainer cooling medium 14 can be configured to be substantially contiguous. Although the insert retainer 2 shown in FIG. 4 includes only four insert apertures 15, eight or any number of insert apertures 15 can be disposed in an insert retainer 2. Should an insert retainer 2 include more than one set of four insert apertures 15, each set can include a retainer cooling medium 14 disposed in a substantially central location as compared to the four insert apertures 15 that comprise each set. Retainer cooling 14 and base cooling mediums allow for increased heat extraction from the insert retainer 2 and inserts 4, 5 which allows for increased cycle time as well as increased ophthalmic device quality. Further, high conductive alloy material can be provided in other non-structural and/or non-functional areas of the insert retainer 2 to further increase heat extraction and insert 4, 5 cooling.

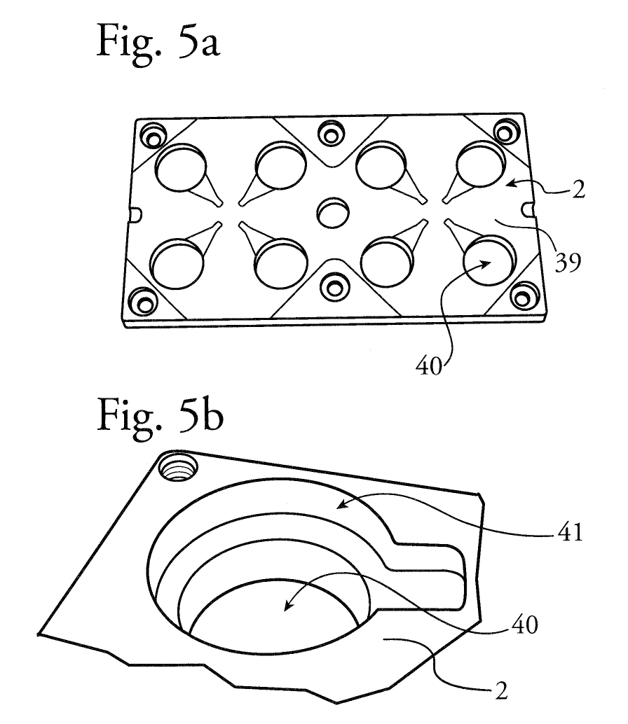

Referring to FIG. 5a, an insert retainer 2 is shown including eight insert apertures 15. Preferably, the insert retainer 2 can have at least one vent channel 40 disposed between a front surface 39 and a back surface of the insert retainer 2. Vent channels 40 can be configured to allow for gases, resulting from the injection molding process, to release thereby reducing the pressure exerted on the insert 4, 5 and the insert retainer 2. Preferably, the vent channel 40 can be not greater than five millimeters in the direction perpendicular to the plane parallel to the front surface 39 of the insert retainer 2. Apart from, or in combination with, a vent channel 40, a recessed area 41 can be disposed in the insert aperture 15, as shown more clearly in FIG. 5b, further allowing for increased effectiveness of gas venting.

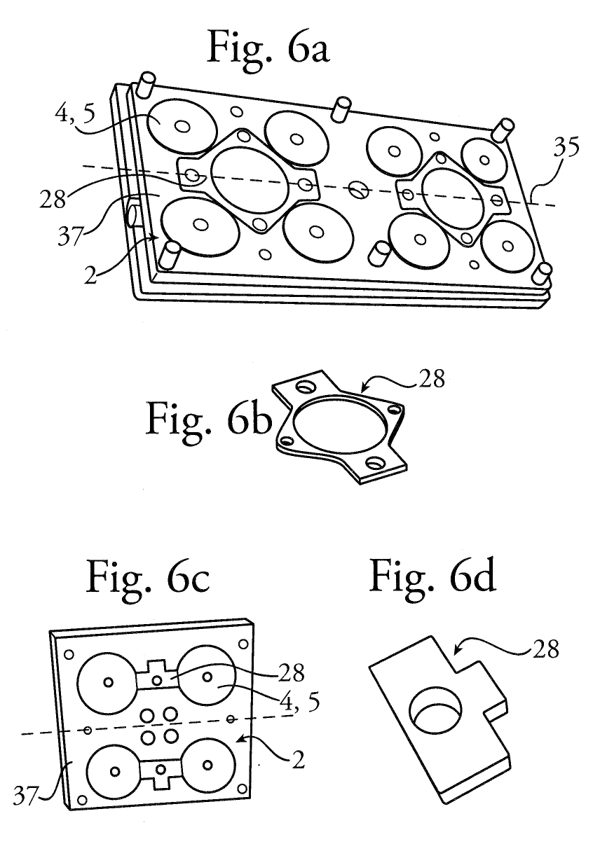

Referring to FIG. 6, various configurations of a rotational indexer 28 are shown. A rotational indexer 28 can be configured to lockably engage at least one insert 4, 5 at a specific angle, as compared to the main axis of the insert retainer 35, such that the insert 4, 5 remains in place. Maintaining insert 4, 5 position is of particular importance when an insert retainer 2 is moved such as when using a handle 18, as discussed further below. Maintaining the integrity of the insert 4, 5 position is also useful for the manufacture of toric lenses which have a plurality of curvature angles and also maintain their orientation when worn and therefore require specific angle positioning. A rotational indexer 28 can be disposed adjacent the back surface 37 of the insert retainer 2 and preferably can be disposed in a recessed area such that no portion of the rotational indexer extends beyond the back surface 37 of the insert retainer. A rotational indexer 28 can be attached to an insert retainer 2 by magnets, adhesive, and/or screws, for example.

More specifically, FIG. 6a shows two rotational indexers 28 attached to an insert retainer 2 having eight inserts 4, 5. Preferably, each rotational indexer 28 can engage at least four inserts 4, 5. Rotational indexers 28 can be configured to lockably engage at least one insert 4, 5 at any angle but preferably can be configured to lockably engage at least one insert 4, 5 at 0 degrees, 45 degrees, 90 degrees, 135 degrees, and 180 degrees as compared to the main axis of an insert retainer 35. For example, FIG. 6a shows two sets of four inserts 4, 5, each lockably engaged at a 45 degree angle, as compared to the main axis 35 of the insert retainer 2, by a respective rotational indexer 28. FIGS. 6b-d show rotational indexers 28 that are configured to lockably engage inserts 4, 5 at a 90 degree angle as compared to the main axis of the insert retainer 35. FIG. 6b shows a rotational indexer 28 that is configured to lockably engaged four inserts 4, 5 while FIG. 6c-d show a rotational indexer 28 that is configured to lockably engage two inserts 4, 5. Although the rotational indexer 28 can be any size, to reduce landscape size and maintain increased exposure of a retainer cooling medium 14, the rotational indexer 28 preferably can be disposed so as not to cover or impede the area included in a retainer cooling medium 14.

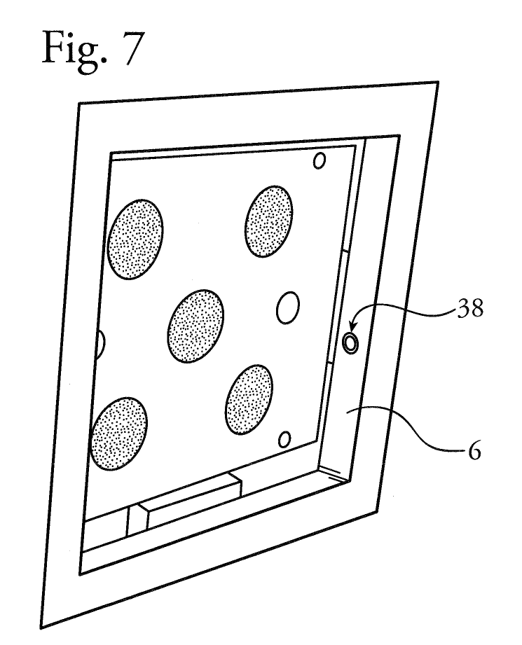

As discussed above, an insert retainer 2 may be attached to a mold half using a number of attachment means including mounting screws 8, brackets, braces, quick clamps, bolts, rods, magnets, and pneumatic coupling systems, for example. Depending on the means for attachment, both of the operator's hands may be required to properly attach the insert retainer 2 to the mold base 6 such as is the case when mounting screws 8 are utilized, for example. In FIG. 7, one embodiment of an insert retainer 2 and mold base 6 is shown having at least one preloaded protrusion 38 extending from the mold base 6. Preferably, at least one preloaded protrusion 38 can be disposed on two opposing sides of the mold base 6. Each preloaded protrusion 38 can be configured to extend and retract such as by a spring mechanism, for example. For each of the preloaded protrusions 38, a corresponding concave portion can be disposed in the insert retainer. In use, an operator can place an insert retainer 2 into a mold half 6 thereby displacing each of the preloaded protrusions 38 toward the mold base 6 until the preloaded protrusions 38 are aligned with the concave portions disposed in the insert retainer 2. Alignment with the insert retainer concavities can cause a spring to expand causing the preloaded protrusions 38 to extend into the insert retainer concavities thereby clipping the insert retainer 2 in place and freeing the operator's hands which can then be used to insert mounting screws 8 or to accomplish any other means for attachment. Additionally, upon removal of the insert retainer 2 from the mold base 6, the insert retainer 2 can remain clipped to the mold base 6 while the operator removes the mounting screws 8, for example, and until a force is applied to the insert retainer 2 sufficient to compress the spring and displace the preloaded protrusions 38.

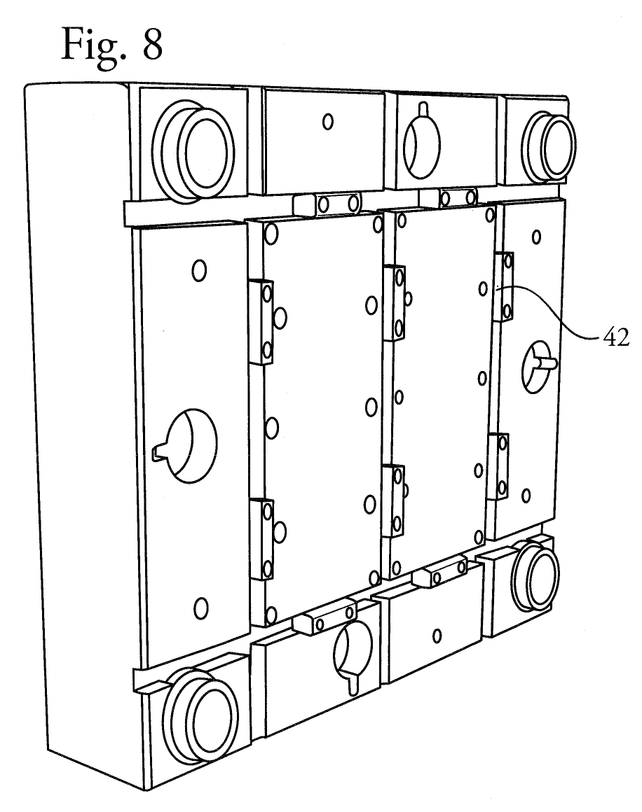

In another embodiment shown in FIG. 8, preloaded keys 42 can be attached to a mold base 6 to allow for increased precision in insert retainer 2 placement upon attachment to a mold base 6. Preferably, at least one preloaded key 42 can be disposed on two opposing sides of the mold base 6. Also preferably, each preloaded key 42 can include at least one angled edge such that insertion of the insert retainer 2 into the mold base 6 can cause the insert retainer 2 to engage the angled edge thereby providing for increased centering of the insert retainer 2 in the mold base 6. Preferably the angle is a high draft angle such as a 15 degree angle, for example. Increased centering of the insert retainer 2 in the mold base 6 can result in significantly increased alignment of the concave 5 and convex 4 inserts during the molding process thereby resulting in higher quality ophthalmic devices.

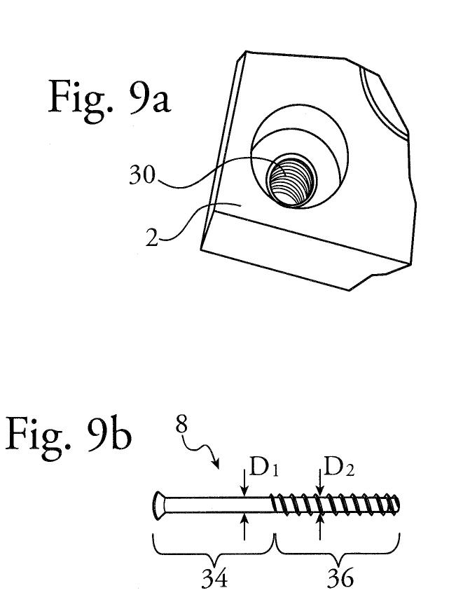

As discussed above, an insert retainer 2 can be attached to a mold half 6 by mounting screws 8 such that each mounting screw 8 can be configured to engage a threaded aperture 30 disposed in the insert retainer 2 as shown in FIG. 9a. In order to reduce mounting screw 8 loss and increase insert retainer 2 changeover time, the mounting screws 8 can be configured to have a first end 34 and a second end 36 such that at least a portion of the first end 34 can be of a smaller diameter D1 than the diameter D2 of at least a portion of the second end 36 and the second end 36 can be threaded as shown in FIG. 9b. Upon insertion of a mounting screw 8, the second end 36 can rotatably engage the threaded aperture 30 of the insert retainer 2. Upon engagement with the threaded aperture 30 by the portion of the first end 34 having a smaller diameter D1 than the diameter D2 of the second end, the mounting screw 8 can slide into the threaded aperture 30 such that removal will require rotating the second end 36 back through the threaded aperture 30. Accordingly, the mounting screws 8 can be configured to attach to an insert retainer 2 such that only rotating back through the threaded aperture 30 of the insert retainer 2 will remove the mounting screws 8 from an insert retainer 2 thereby resulting in reduced mounting screw 8 loss.

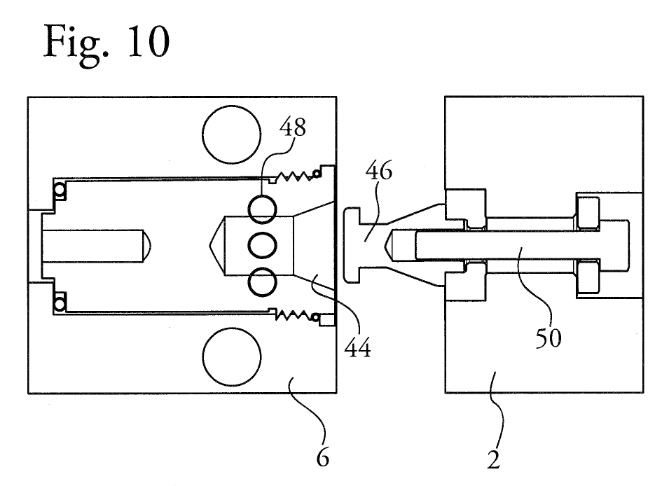

In another embodiment, a quick clamp method can be used to attach and remove an insert retainer 2 to a mold base 6. FIG. 10 shows a mold base 6 having a cylinder lock 44 disposed toward a surface adjacent to an insert retainer 2 upon attachment of the insert retainer 2 to the mold base 6. The cylinder lock 44 can be configured to receive a male knob 46 protruding from an insert retainer 2. The male knob 46 can be a conical shape, for example, and can be attached by a screw 50 disposed in the insert retainer 2 and extending into a threaded aperture disposed in the male knob 46. Alternatively, the male knob 46 can be attached to the insert retainer 2 by magnet or adhesive, for example. The cylinder lock 44 can include at least one spring (not shown) configured to engage at least one wedge (not shown) upon application of pneumatic pressure. Pneumatic pressure can be delivered through channels in the mold base 6 and the pressure can be applied by an operator engaging a button, for example. Upon insertion of the insert retainer 2 into the mold base 6 and application of pneumatic pressure, a spring can be configured to expand and displace a wedge which can be configured to engage at least one sphere 48 such that the sphere 48 is displaced toward the male knob 46 locking the male knob 46 in place in the cylinder lock 44. Preferably, the cylinder lock 44 includes a plurality of spheres 48 as shown in FIG. 10. Upon removal of the insert retainer 2 from the mold base 6, pneumatic pressure can be applied such that a spring can be compressed and a wedge can be displaced causing each of the spheres 48 to displace away from the male knob 46 and allowing the male knob 46 to move relative to the cylinder lock 44. While the male knob 46 is locked in place in the cylinder lock 44, the cylinder lock 44 can be configured to stay mechanically locked until pneumatic pressure is once again applied. Accordingly, even if pneumatic pressure is lost, the male knob 46 and insert retainer 2 can stay locked to the cylinder lock 44 and mold base 6.

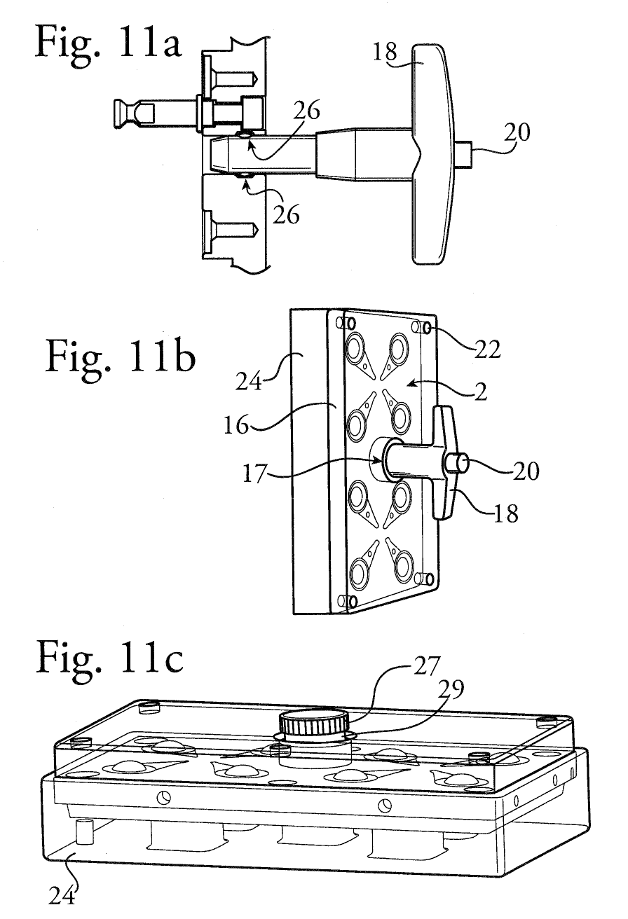

In order to provide for efficient insertion and removal of insert retainers 2 as well as to maintain the integrity of optical inserts 4, 5, a handle 18 can be used in the absence of, or in combination with, a cover 16 as shown in FIG. 11. A cover 16 can have a cover hole 17 configured to align with a retainer hole 19 (see FIG. 3a). In a preferred embodiment, an ergonomic handle 18 can be attached to a cover such as by a threaded portion and associated threaded cover hole 17 or displaceable protrusions and associated cover hole concavities, for example, such that a portion of the handle 18 can extend beyond the cover hole 17. A button 20 and associated button actuation system can be disposed on the handle 18 such that operator engagement with the button 20 can cause at least one displaceable protrusion 26 to either extend or retract into or out of at least one concavity disposed adjacent the retainer hole thereby attaching the handle 18 to the insert retainer 2 as shown in FIG. 11a. To insert an insert retainer 2 into a mold base 6, an operator can place the handle 18 into the retainer hole 19 and engage the button 20, for example, and manipulate the insert retainer 2 using the handle 18. The operator can then manipulate the insert retainer 2 into the mold base 6 by once again engaging the button 20 to release the handle 18 and associated cover 16. To remove an insert retainer 2 from a mold base 6, an operator can place a handle 18, and attached cover 16, into the insert retainer 2 and engage the button 20, for example, to manipulate the insert retainer 2 away from the mold base 6. The insert retainer 2 can then be removed from the mold base 6 and manipulated using one hand by carrying the handle 18 while advantageously maintaining the integrity of the optical surface of the inserts 4, 5.

In a preferred embodiment, a handle 18 can be both removed from and attached to a cover 16, as discussed above. FIG. 11b shows one embodiment of an insert retainer storage arrangement having a handle 18 attached to a cover 16. Removing the handle 18 can allow for a more efficient storage solution as shown in FIG. 11c. FIGS. 11b-c also show a retainer holder 24 disposed below the insert retainer 2 and attached to the cover 16. Preferably, the retainer holder 24 can be configured to receive an insert retainer 2 such that each side of the retainer holder 24 is minimally larger than a corresponding side of the insert retainer 2. In one embodiment, the cover 16 can contain at least one bore 22 and the retainer holder 24 can have at least one threaded receiver such that the cover 16 can be attached to the retainer holder 24 using threaded screws as shown in FIG. 11b. In another embodiment shown in FIG. 11c, the retainer holder 24 can have a threaded protrusion 29 configured to extend through both the retainer hole 19 (see FIG. 3a) and the cover hole 17. A threaded cap 27 can then be rotated onto the threaded protrusion 29 thereby maintaining the cover 16 between the threaded cap 27 and the retainer holder 24. Accordingly, the retainer holder 24 and cover 16 can protect both sides of the optical inserts 4, 5 such that the insert retainers 2 can be stacked and stored providing for an advantageously efficient storage arrangement.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein.

Modifications and substitutions by one of ordinary skill in the art are considered to be within the scope of the present invention, which is not to be limited except by the following claims.

What is claimed is:

1. A molding system for forming ophthalmic devices, comprising:
at least one mold half having a base wherein the at least one mold half is configured to be engaged by an injection molding machine;
at least one insert retainer having a thickness not greater than 15 millimeters, the at least one insert retainer including at least one insert aperture, each insert aperture being configured to receive an insert wherein each of the inserts is configured to receive thermoplastic material for forming at least one lens curve wherein the at least one mold half is configured to receive the at least one insert retainer; and
means for attaching the at least one insert retainer to the at least one mold half.

2. The molding system for forming ophthalmic devices of claim 1 wherein each of the inserts is a convex insert and wherein the insert retainer thickness is not greater than 10 millimeters.

3. The molding system for forming ophthalmic devices of claim 1 wherein the plurality of inserts is selected from the group consisting of four concave inserts, four convex inserts, eight concave inserts, and eight convex inserts.

4. The molding system for forming ophthalmic devices of claim 1 wherein the means for attaching the at least one insert retainer is selected from the group consisting of at least one bracket, at least one brace, at least one bolts, at least one quick clamp, at least one coupling system, at least one rod, and at least one magnet.

5. A molding system for forming ophthalmic devices, comprising:
at least one mold half having a base wherein the at least one mold half is configured to be engaged by an injection molding machine;
at least one insert retainer including at least one insert aperture, each insert aperture being configured to receive an insert wherein each of the inserts is configured to receive thermoplastic material for forming at least one lens curve wherein the at least one mold half is configured to receive the at least one insert retainer; and
at least one retainer cooling medium disposed in the insert retainer.

6. The molding system for forming ophthalmic devices of claim 5 including at least one set of four insert apertures, each set including a retainer cooling medium disposed in a substantially central location as compared to the four insert apertures.

7. The molding system for forming ophthalmic devices of claim 5 further including at least one base cooling medium disposed in the base of the at least one mold half and adjacent the at least one retainer cooling medium when the at least one insert retainer is received by the at least one mold half.

8. The molding system for forming ophthalmic devices of claim 7 wherein both the at least one retainer cooling medium and the at least one base cooling medium are comprised of a conductive alloy selected from the group consisting of copper, copper chromium, copper zinc, brass, and nickel-coated brass.

9. A molding system for forming ophthalmic devices, comprising:
at least one insert retainer having a retainer hole wherein the at least one insert retainer further includes at least one insert aperture, each insert aperture being configured to receive an insert wherein each of the inserts is configured to receive thermoplastic material for forming at least one lens curve;
a cover having a cover hole wherein the cover hole is configured to be substantially aligned with the retainer hole; and
a handle configured to protrude through the cover hole wherein the handle includes means for both attaching and detaching the handle to the at least one insert retainer.

10. The molding system for forming ophthalmic devices of claim 9 wherein the means for both attaching and detaching include a button attached to the handle wherein the button is configured to engage at least one displaceable protrusion wherein the at least one displaceable protrusion is configured to engage at least one concave portion disposed adjacent the retainer hole upon attachment of the handle to the at least one insert retainer.

11. The molding system for forming ophthalmic devices of claim 9 further including a retainer holder wherein the retainer holder is configured to receive the at least one insert retainer and means for attaching the retainer holder to the cover.

12. The molding system for forming ophthalmic devices of claim 11 wherein the means for attaching the retainer holder to the cover further include:
at least one cover bore disposed in the cover;
at least one threaded receiver attached to the retainer holder;
at least one threaded screw; and
wherein both the at least one cover bore and the at least one threaded receiver are configured to receive the at least one threaded screw.

13. The molding system for forming ophthalmic devices of claim 11 wherein the means for attaching the retainer holder to the cover further include a threaded knob and a threaded protrusion disposed in the retainer holder wherein the threaded cap is configured to engage the threaded protrusion.

14. A molding system for forming ophthalmic devices, comprising:
at least one mold half having a base wherein the at least one mold half is configured to be engaged by an injection molding machine;
at least one insert retainer including at least one insert aperture, each insert aperture being configured to receive an insert wherein each of the inserts is configured to receive thermoplastic material for forming at least one lens curve wherein the at least one mold half is configured to receive the at least one insert retainer;
wherein each of the insert retainers has a front surface and a back surface; and
at least one vent channel disposed between the front surface and the back surface.

15. The molding system for forming ophthalmic devices of claim 14 wherein the at least one vent channel is not greater than 5 millimeters in the direction perpendicular to the plane parallel to the front and the back surfaces of the at least one insert retainer.

16. The molding system for forming ophthalmic devices of claim 14 further including:
at least one rotational indexer configured to lockably engage at least one of the inserts of the at least one insert retainer; and
means for attaching the at least one rotational indexer to the at least one insert retainer.

17. The molding system for forming ophthalmic devices of claim 16 wherein the rotational indexer is configured to lockably engage at least one of the plurality of inserts of the at least one insert retainer at a specific angle relative to the main axis of the at least one insert retainer wherein the specific angle is selected from the group consisting of 0 degrees, 45 degrees, 90 degrees, 135 degrees, and 180 degrees

18. The molding system for forming ophthalmic devices of claim 16 wherein the means for attaching is selected from the group consisting of magnets, adhesive, and screws.

19. The molding system for forming ophthalmic devices of claim 14 further including:
at least one threaded aperture disposed in the at least one insert retainer wherein the at least one threaded aperture is configured to receive at least one of the mounting screws; and
wherein the base of the at least one mold half has at least one threaded aperture configured to receive at least one of the mounting screws.

20. The molding system for forming ophthalmic devices of claim 14 further including:
at least one preloaded protrusion disposed in the base of the mold half; and
at least one concave portion disposed in the at least one insert retainer such that the at least one preloaded protrusion is configured to engage the concave portion of the at least one insert retainer upon reception of the at least one insert retained by the at least one mold half.

21. The molding system for forming ophthalmic devices of claim 20 further including two preloaded protrusions wherein the two preloaded protrusions are disposed on opposing sides of the base.

22. The molding system for forming ophthalmic devices of claim 14 further including at least one pre-loaded key wherein each of the pre-loaded keys is configured to communicate with the insert retainer.

23. The molding system for forming ophthalmic devices of claim 21 wherein each of the pre-loaded keys has a 15 degree draft angle.
